(19) United States
(12) Patent Application Publication
(10) Pub. No.: US 2024/0080810 A1
(43) Pub. Date: Mar. 7, 2024

(54) RADIO COMMUNICATION NODE AND RADIO COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/272,469

(22) PCT Filed: Jan. 15, 2021
(86) PCT No.: PCT/JP2021/001369

§ 371 Date: Jul. 14, 2023

(51) Int. Cl. H04W 72/04; H04B 7/06

(52) U.S. Cl. CPC H04W 72/04; H04B 7/0613

(57) ABSTRACT

A radio communication node includes: a control unit that a first communication using a first radio link with a lower node and a second communication using a second radio link with a terminal, wherein the control unit: controls the first communication using a first radio resource based on a configuration of a radio resource used in the first radio link, when performing a simultaneous communication of the first communication and the second communication, and performs the first communication using a second radio resource at least including the first radio resource when a condition is satisfied not to perform the simultaneous communication of the first communication and the second communication.

### TECHNICAL FIELD

The present disclosure relates to radio communication nodes and radio communication methods that establish radio access and radio backhaul.

### BACKGROUND ART

The 3rd Generation Partnership Project (3GPP) has specified the 5th generation mobile communication system (Also known as 5G, New Radio (NR) or Next Generation (NG)) and is also in the process of specifying the next generation called Beyond 5G, 5G Evolution or 6G.

For example, NR's Radio Access Network (RAN) specifies Integrated Access and Backhaul (IAB), which integrates radio access to terminals (User Equipment, UE) and radio backhaul between radio communication nodes such as radio base stations (gNBs) (see Non-Patent Literature 1).

In IAB, an IAB node has a Mobile Termination (MT), which is a function for connecting to a parent node (which may be called an IAB donor), and a Distributed Unit (DU), which is a function for connecting to a child node or UE.

Also, in IAB, simultaneous transmission and reception (Simultaneous communication below) using time division recovery (TDD) or the like is supported for the radio link (Link_parent) between the parent node and the IAB node and the radio link (Link_child) between the IAB node and the child node.

### CITATION LIST

### Non-Patent Literature

Non-Patent Literature 1: 3GPP TS 38.213 V 16.1.0, 3rd Generation Partnership Project; Technical Specification Group Radio Access Network; NR; Physical layer procedures for control (Release 16), 3GPP, March 2020

### SUMMARY OF INVENTION

By the way, the IAB is studying not only TDD but also simultaneous communication using frequency division decoding (FDD) between Link_parent (That is, DU) and Link_child (i.e., MT).

Against this background, the inventors, after careful study, found it necessary to determine how to use radio resources in cases where simultaneous communication is not performed in FDD where simultaneous communication is assumed.

Therefore, the following disclosure has been made in view of this situation, and the purpose is to provide radio communication nodes and radio communication methods that can appropriately use radio resources as DU resources.

An aspect of the present disclosure is a radio communication node comprising: a control unit that a first communication using a first radio link with a lower node and a second communication using a second radio link with a terminal, wherein the control unit: controls the first communication using a first radio resource based on a configuration of a radio resource used in the first radio link, when performing a simultaneous communication of the first communication and the second communication, and performs the first communication using a second radio resource at least including the first radio resource when a condition is satisfied not to perform the simultaneous communication of the first communication and the second communication.

An aspect of the present disclosure is a radio communication method comprising: a step A of controlling a first communication using a first radio link with a lower node and a second communication using a second radio link with a terminal, wherein the step A includes: controlling the first communication using a first radio resource based on a configuration of a radio resource used in the first radio link, when performing a simultaneous communication of the first communication and the second communication, and performing the first communication using a second radio resource at least including the first radio resource when a condition is satisfied not to perform the simultaneous communication of the first communication and the second communication.

### BRIEF DESCRIPTION OF DRAWINGS

FIG. 1 is an overall schematic diagram of radio communication system 10.

FIG. 2 shows an example of the basic configuration of the IAB.

FIG. 3 shows the functional block configuration of the radio communication node 100B (IAB node).

FIG. 4 illustrates the first example of a DU resource.

FIG. 5 illustrates the second example of a DU resource.

FIG. 6 illustrates the third example of a DU resource.

FIG. 7 illustrates the fourth example of a DU resource.

FIG. 8 illustrates the first example of a DU resource in Example 1 of the modification.

FIG. 9 illustrates the second example of a DU resource in Example 1 of the modification.

FIG. 10 is a diagram for explaining the third example of the DU resource relating to Modification Example 1.

FIG. 11 is a diagram for explaining the fourth example of the DU resource relating to Modification Example 1.

FIG. 12 is a diagram for explaining the fifth example of the DU resource relating to Modification Example 1.

FIG. 13 is a diagram showing an example of the hardware configuration of radio communication nodes 100A to 100C.

### MODES FOR CARRYING OUT THE INVENTION

Exemplary embodiments of the present invention are explained below with reference to the accompanying drawings. Identical functions and configurations are denoted by the same or similar symbols and their descriptions are omitted as appropriate.

### (1) Overall Schematic Configuration of the Radio Communication System

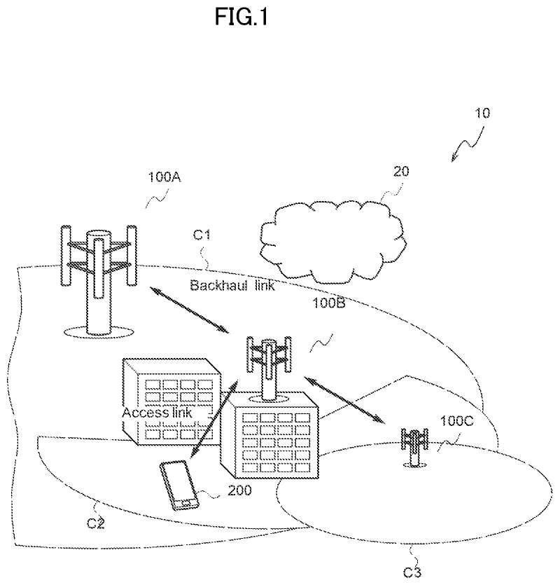

FIG. 1 is an overall schematic diagram of a radio communication system 10 according to the present embodiment. radio communication system 10 is a radio communication system according to 5G New Radio (NR) and is composed of multiple radio communication nodes and terminals. The radio communication system 10 may be a radio communication system according to a scheme called Beyond 5G, 5G Evolution or 6G.

Specifically, the radio communication system 10 includes a Next Generation-Radio Access Network 20 (NG-RAN 20, radio communication nodes 100A, 100B, 100C, and a terminal 200 (hereinafter, UE 200, User Equipment).

The radio communication nodes 100A, 100B, and 100C can form cell C1, cell C2, and cell C3, respectively. The radio communication nodes 100A, 100B, and 100C can set radio access (Access link) with the UE 200 and radio backhaul (Backhaul link) between the radio communication nodes via the cell. Specifically, backhaul (transmission path) by radio link may be set between the radio communication node 100A and the radio communication node 100B, and between the radio communication node 100B and the radio communication node 100C.

The configuration that integrates radio access with the UE 200 and radio backhaul between the radio communication nodes is called Integrated Access and Backhaul (IAB).

The IAB reuses existing functions and interfaces defined for radio access. In particular, Mobile-Termination (MT), gNB-DU (Distributed Unit), gNB-CU (Central Unit), User Plane Function (UPF), Access and Mobility Management Function (AMF) and Session Management Function (SMF) and corresponding interfaces such as NR Uu (between MT and gNB/DU), F1, NG, X2 and N4 may be used as baselines.

The radio communication node 100A is connected to NG-RAN 20 and core network (Next Generation Core (NGC) or 5GC) via a wired transmission path such as fiber transport. Note that NG-RAN and NGC may be included and simply expressed as “network.”

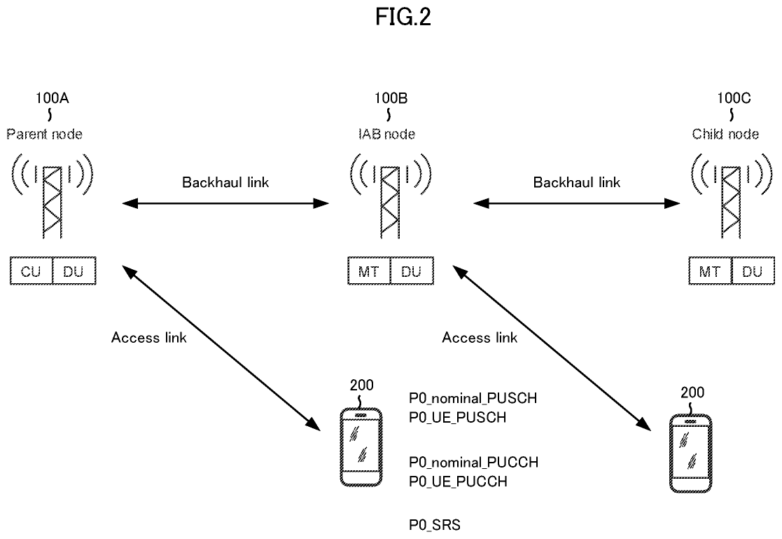

FIG. 2 shows an example of the basic configuration of the IAB. As shown in FIG. 2, in this embodiment, the radio communication node 100A constitutes an IAB donor in the IAB, and radio communication node 100B (and radio communication node 100C) may constitute an IAB node in the IAB.

The IAB donor may be referred to as the upper node in relation to the IAB node. In addition, the IAB donor may be referred to as the parent node. Also, the IAB donor has a CU, and the parent node is simply used as a name in relation to the IAB node (or child node) and may not have a CU. The IAB node may be called a subordinate node in relation to the IAB donor (parent node). The child node may also include a UE 200.

A backhaul link is established between the IAB donor and the IAB node. Specifically, a radio link called Link_parent may be established. A radio link (Backhaul link) is established between the IAB node and the child node. Specifically, a radio link called Link_child may be set up.

Link_parent may consist of a downward-facing DL Parent BH and an upward-facing UL Parent BH. Link_child may consist of a downward-facing DL Child BH and an upward-facing UL Child BH.

An IAB node has a Mobile Termination (IAB-MT), which is a function for connecting with an IAB donor, and a Distributed Unit (IAB-DU), which is a function for connecting with a child node (or UE 200). The child node also has an MT and a DU. The IAB donor has a Central Unit (CU) and a DU.

The radio resources utilized by a DU include, from the DU perspective, downlink (DL), uplink (UL) and flexible time-resource (D/U/F), which are classified as either Hard, Soft or Not Available (H/S/NA) types. Also, within Soft (S), available or not available is specified.

Flexible time-resource (F) is a radio resource (time resource and/or frequency resource) that can be used for either DL or UL. Also, “Hard” is a radio resource that is always available for a DU Link child where the corresponding time resource is connected to a child node or UE, and “Soft” is a radio resource (DU resource) whose availability of the corresponding time resource for a DU Link child is explicitly or implicitly controlled by the IAB donor (or parent node).

In addition, if it is Soft (S), the radio resource to be notified can be determined based on IA or INA.

“IA” means that the DU resource is explicitly or implicitly indicated as available. “INA” also means that the DU resource is explicitly or implicitly indicated as unavailable.

In the embodiment, the radio access and radio backhaul can be either half-duplex or full-duplex. In addition, time division multiplexing (TDM), space division multiplexing (SDM) and frequency division multiplexing (FDM) are available as multiplexing schemes.

When the IAB node operates in half-duplex communication (half-duplex), DL Parent BH is on the receiving (RX) side, UL Parent BH is on the sending (TX) side, DL Child BH is on the sending (TX) side and UL Child BH is on the receiving (RX) side. In the case of time division duplex (TDD), the setting pattern of DL/UL in the IAB node is not limited to DL-F-UL only, but only radio backhaul (BH), UL-F-DL or other setting patterns may be applied. In this embodiment, simultaneous operation of DU and MT in the IAB node is realized using SDM/FDM.

### (2) Function Block Configuration of Radio Communication System

Next, the functional block configuration of the radio communication system 10 is described. Specifically, the functional block configuration of the radio communication nodes 100A, 100B, and 100C constituting the TAB node is described.

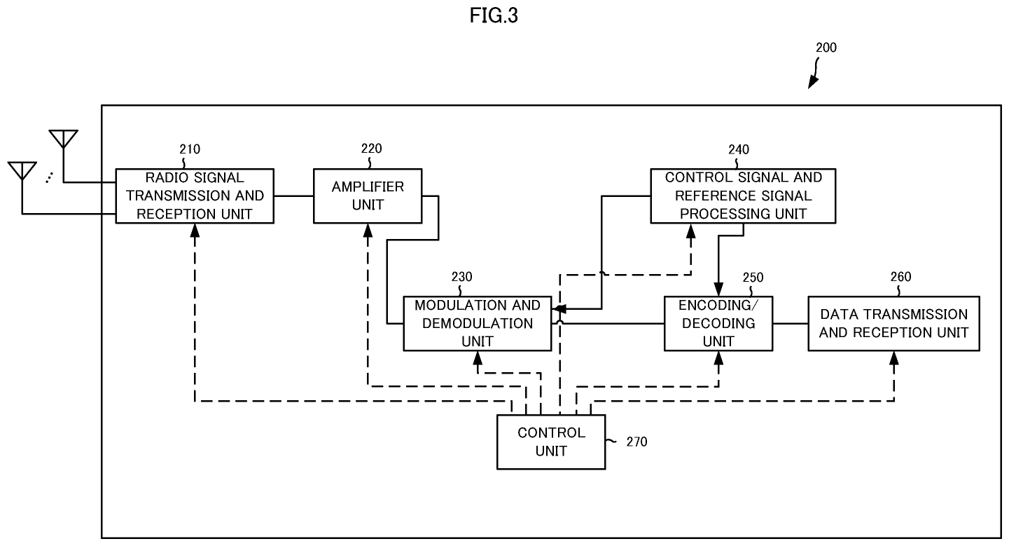

FIG. 3 is a functional block diagram of the radio communication node 100B (IAB node). Note that the radio communication node 100A is different from the radio communication node 100B that functions as an IAB node in that it functions as an IAB donor (parent node). In addition, the radio communication node 100C is different from the radio communication node 100B in that it functions as a child node. Hereafter, the case of the radio communication node 100B will be described as an example.

As shown in FIG. 3, the radio communication node 100B includes a radio signal transmission and reception unit 110, an amplifier unit 120, a modulation and demodulation unit 130, a control signal processing unit 140, an encoding/decoding unit 150 and a control unit 170.

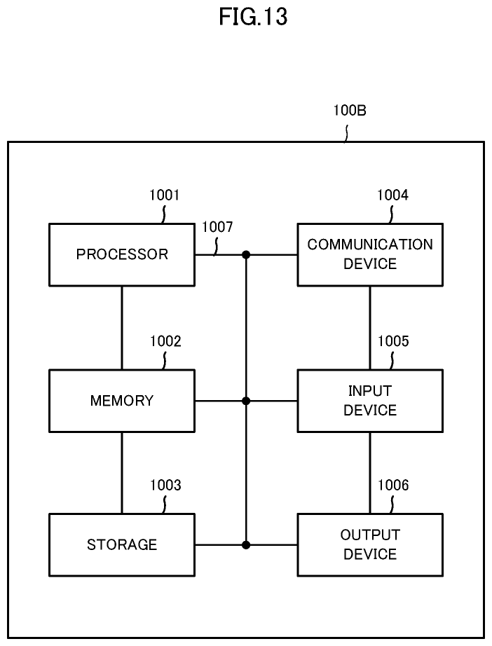

Note that only the main functional blocks related to the description of the embodiment are shown in FIG. 5, and the radio communication node 100B has other functional blocks (For example, the power supply). Also, FIG. 5 shows the functional block configuration of the radio communication node 100B, and refer to FIG. 13 for the hardware configuration.

The radio signal transmission and reception unit 110 transmits and receives radio signals in accordance with NR. By controlling radio (RF) signals transmitted from multiple antenna elements, the radio signal transmission and reception unit 110 can support Massive MIMO for generating more directional beams, Carrier Aggregation (CA) for bundling multiple component carriers (CCs), and Dual Connectivity (DC) for simultaneously communicating between the UE and each of the two NG-RAN nodes.

The radio signal transmission and reception unit 110 can transmit and receive radio signals to and from the radio communication node 100A via cell C1. The radio signal transmission and reception unit 110 can also transmit and receive radio signals to and from the radio communication node 100C or the UE 200 via cell C2.

The amplifier unit 120 is composed of a PA (Power Amplifier)/LNA (Low Noise Amplifier), etc. The amplifier unit 120 amplifies the signal output from the modulation and demodulation unit 130 to a predetermined power level. The amplifier unit 120 also amplifies the RF signal output from radio signal transmission and reception unit 110.

The modulation and demodulation unit 130 performs data modulation/demodulation, transmission power setting and resource block allocation for each specific destination (Radio communication node 100A, 100B or UE 200).

The control signal processing unit 140 performs processing related to various control signals transmitted and received by the radio communication node 100B. Specifically, the control signal processing unit 140 receives various control signals transmitted from the radio communication node 100A (or radio communication node 100C, hereinafter the same) and the UE 200 via a control channel, for example, control signals of a radio resource control layer (RRC). The control signal processing unit 140 also transmits various control signals to the radio communication node 100A or the UE 200 via a control channel.

Furthermore, the control signal processing unit 140 can perform processing using a reference signal (RS) such as a Demodulation Reference Signal (DMRS) and a Phase Tracking Reference Signal (PTRS).

DMRS is a known reference signal (pilot signal) between individual base stations and terminals for estimating a fading channel used for data demodulation. PTRS is a terminal-specific reference signal for the purpose of estimating phase noise, which is a problem in high frequency bands.

In addition to DMRS and PTRS, the reference signal may include Channel State Information-Reference Signal (CSI-RS), Sounding Reference Signal (SRS), and Positioning Reference Signal (PRS) for location information.

The channel includes a control channel and a data channel. The control channels include PDCCH (Physical Downlink Control Channel), PUCCH (Physical Uplink Control Channel), PRACH (Physical Random Access Channel), and PBCH (Physical Broadcast Channel).

The data channels include PDSCH (Physical Downlink Shared Channel), and PUSCH (Physical Uplink Shared Channel). The signals may include channels and reference signals.

In the embodiment, the control signal processing unit 140 may receive downlink control information (DCI) that specifies the frequency resources available in the frequency direction as radio resources (DU resources) to be allocated to the radio link (Link child) with the lower node (For example, radio communication node 100C). The information element that specifies the frequency resources available in the frequency direction may take an information element indicating that it is available as a DU resource in Soft (S) (IA (Indication Available) and an information element indicating that it is not available as a DU resource in Soft (S) (INA (Indication Not-Available). The control signal processing unit 140 may receive a DCI from an LAB donor (parent node). For example, the control signal processing unit 140 may receive a DCI from a radio communication node 100A.

Such a DCI may be a newly defined DCI or a DCI that is an extension of an existing DCI. An existing DCI may be a DCI that designates a time resource available in the time direction as a radio resource (DU resource). A DCI that designates a time resource available in the time direction may be a DCI that has a format of DCI format 2_5 (see 3GPP TS 38.212 Chapter 7.3).

The DU resource may be specified in units in the time direction (For example, a symbol or a slot) and in units in the frequency direction (For example, subcarriers).

The encoding/decoding unit 150 performs data division/concatenation and channel coding/decoding for each predetermined communication destination (radio communication node 100A or UE 200).

Specifically, the encoding/decoding unit 150 divides data output from the data transmission and reception unit 160 into predetermined sizes and performs channel coding on the divided data. The encoding/decoding unit 150 also decodes the data output from the modulation and demodulation unit 130 and concatenates the decoded data.

The data transmission and reception unit 160 transmits and receives protocol data units (PDU) and service data units (SDU). Specifically, the data transmission and reception unit 160 performs assembly/disassembly of PDUs/SDUs in multiple layers (Media access control layer (MAC), radio link control layer (RLC), and packet data convergence protocol layer (PDCP), etc.).

The control unit 170 controls each functional block constituting the radio communication node 100B. In particular, in this embodiment, control unit 170 performs control regarding simultaneous transmission and reception between the IAB-MT and the IAB-DU.

In the embodiment, the control unit 170 controls the first communication (Below: DU Communications) using the lower node (For example, radio communication node 100C) and the first radio link (DU Link_child), and controls the second communication (Below: MT Communication) using the terminal (For example, UE 200) and the second radio link (Below: MT link). When performing simultaneous communication of DU communication and MT communication, the control unit 170 controls DU communication using the first radio resource (Below, first DU resource) based on the radio resource settings used in the DU Link_child. When the conditions for not performing simultaneous communication of DU communication and MT communication are satisfied, the control unit 170 performs DU communication using the second radio resource (Below, 2nd DU resource) containing at least the first DU resource. The control unit 170 may dynamically control communication using the DU Link child based on the DCI. For example, the control unit 170 performs DU communication using the DU Link child with frequency resources designated as available by the DCI.

### (3) DU Resources

In the following, the comparison between the DU resources in the case of performing simultaneous communication of DU communication and MT communication and the DU resources in the case of performing simultaneous communication of DU communication and MT communication is described. DU communication may be referred to as DU transmission and reception (DU TX/RX). MT communication may be referred to as MT transmission and reception (MT TX/RX).

This section describes a case where DU resources of Hard, Soft-IA, Soft-INA and NA are allocated in the frequency direction in a case where simultaneous communication is performed. That is, the first and second DU resources are frequency resources in the frequency direction. In the case where simultaneous communication is performed, DU communication is performed using Hard and Soft-IA DU resources (That is, the first DU resource). Hard, Soft-IA, Soft-INA and NA may be assigned by a semi-static (semi-static) configuration or by dynamic designation. Hard, Soft-IA, Soft-INA and NA may be assigned explicitly or implicitly. DU resources in the frequency direction (Hard, Soft-IA, Soft-INA, NA) may be assigned by unit in the time direction. The unit in the time direction may be symbol or slot. Units in the time direction may be those to which DL, UL and Flexible time-resource (D/U/F) are applied in the time direction. Units in the time direction may be those to which Hard, Soft and NA are applied in the time direction.

In such a case, DU resources (That is, the second DU resource) used for DU communication will be mainly described in the case where simultaneous communication is not performed.

### (3.1) First Example

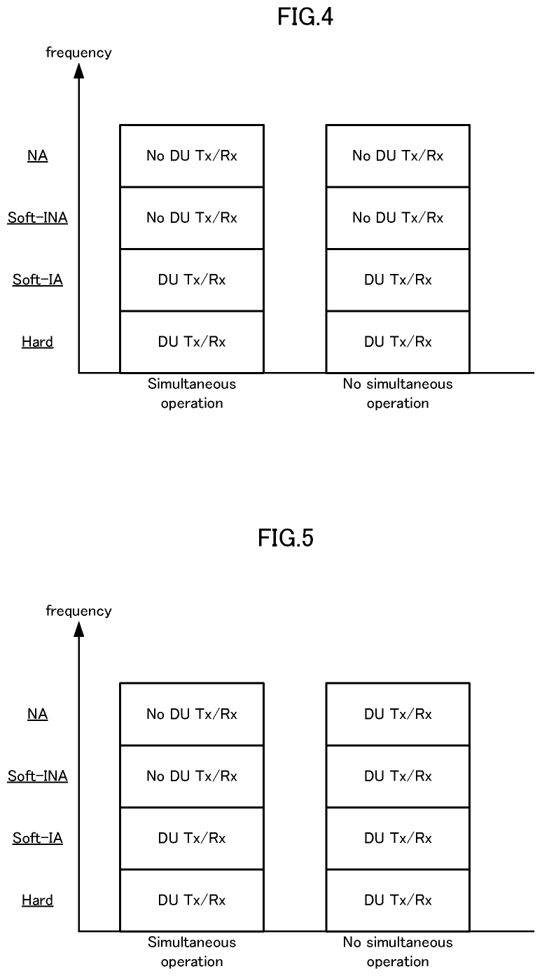

In the first example, as shown in FIG. 4, in the case where simultaneous communication is not performed, the second DU resource includes the DU resources of Hard and Soft-IA, but not the DU resources of Soft-INA and NA. That is, the second DU resource used in the case where simultaneous communication is not performed is the same as the first DU resource used in the case where simultaneous communication is performed. Since the IAB nodes (For example, radio communication node 100B) that do not perform simultaneous communication cannot use the DU resources of Soft-INA and NA for MT communication, the DU resources of Soft-INA and NA are not used.

### (3.2) Second Example

In the second example, as shown in FIG. 5, in the case where simultaneous communication is not performed, the second DU resource includes the DU resources of Hard, Soft-IA, Soft-INA and NA. That is, the second DU resource used in the case where simultaneous communication is not performed is larger than the first DU resource used in the case where simultaneous communication is performed. IAB nodes (For example, radio communication node 100B) that do not perform simultaneous communication may perform DU communication using DU resources of Soft-INA and NA in addition to Hard and Soft-IA.

### (3.3) Third Example

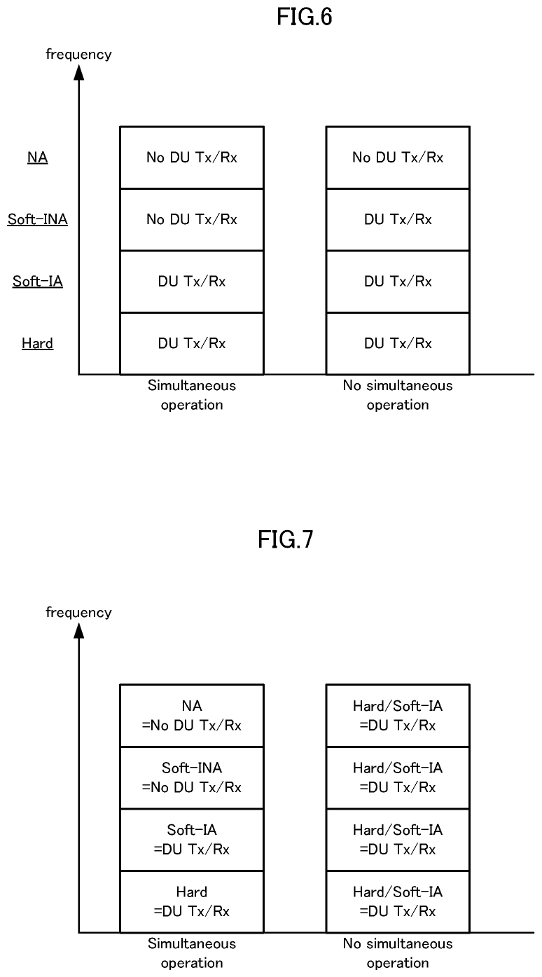

In the third example, as shown in FIG. 6, in the case where simultaneous communication is not performed, the second DU resource includes the DU resources of Hard, Soft-IA and Soft-INA, but not the DU resource of NA. That is, the second DU resource used in the case where simultaneous communication is not performed is larger than the first DU resource used in the case where simultaneous communication is performed. IAB nodes (For example, radio communication node 100B) that do not perform simultaneous communication may perform DU communication using DU resources of Soft-INA in addition to Hard and Soft-IA.

### (3.4) Fourth Example

In the fourth example, as shown in FIG. 7, an IAB node (For example, radio communication node 100B) where simultaneous communication is not performed may assume that all frequency resources are Hard or all frequency resources are Soft-IA. That is, the second DU resource used in the case where simultaneous communication is not performed is larger than the first DU resource used in the case where simultaneous communication is performed. An IAB node that does not perform simultaneous communication may perform DU communication using all frequency resources.

In such a case, the UE 200 may assume that it is unable to perform MT communication with an IAB node that does not perform simultaneous communication. On the other hand, the child node (For example, radio communication node 100C) may assume that it is able to perform DU communication using all frequency resources with an IAB node that does not perform simultaneous communication.

### (4) Conditions for not Performing Simultaneous Communication

The conditions for not performing simultaneous communication are described below. In other words, the condition for not performing simultaneous communication may be an inside-out relationship with the condition for performing simultaneous communication.

First, the condition for not performing simultaneous communication may include the condition that the IAB node (For example, radio communication node 100B) does not support simultaneous communication (Hereafter, the first condition). Ability information indicating whether the IAB node supports simultaneous communication may be defined. The IAB node may report capability information to the IAB donor or parent node. Whether or not the IAB node supports simultaneous communication may be read as whether or not it supports FDM that multiplexes Backhaul link (DU) and Access link (MT).

Second, the condition for not performing simultaneous communication may include the condition that simultaneous communication is not configured (Hereafter, the second condition). Simultaneous communication may be configured or specified by the IAB donor or parent node. Simultaneous communication may be configured or specified by at least one of the RRC message, MAC CE message and DCI. Simultaneous communications may be established or specified based on the reporting of capability information. Simultaneous communications may be explicitly established or specified or may be implicitly established or specified.

Simultaneous communications may be assigned on a per-unit basis in the time direction. The unit in the time direction may be symbol or slot. The unit in the time direction may be the unit to which DL, UL and Flexible time-resource (D/U/F) are applied in the time direction. The unit in the time direction may be the unit to which Hard, Soft and NA are applied in the time direction. How simultaneous communication is configured or specified may be determined by what configuration or designation the IAB node supports.

Third, conditions under which simultaneous communication is not performed may include conditions under which MT communication (MT TX/RX) is not scheduled (Hereafter, the third condition).

Fourth, the condition for not performing simultaneous communications may include a condition (Hereafter, the fourth condition) where the first communication (DU communication) is scheduled at a time when simultaneous transmission is not supported. For example, the timing when simultaneous transmission is not supported may be when the IAB node (For example, radio communication node 100B) is unable to receive a TA (Timing Advance) from the UE 200. The timing when simultaneous transmission is not supported may be when the TA (Timing Advance) that the IAB node receives from the UE 200 is outside the prescribed range. The prescribed tooth may be determined by the capability of the IAB node.

Fifth, the condition for not performing simultaneous communication may be a combination of two or more conditions selected from the first to fourth conditions described above.

As described above, the condition for not performing simultaneous communication may be an inside-out relationship with the condition for performing simultaneous communication. Therefore, the condition for performing simultaneous communication may be the following condition.

That is, the condition for performing simultaneous communication may include a condition (fifth condition) under which the IAB node (For example, radio communication node 100B) supports simultaneous communication. The condition for performing simultaneous communication may include a condition (Hereafter, the sixth condition) under which simultaneous communication is configured. The condition for performing simultaneous communication may include a condition (Hereafter, the seventh condition) under which MT communication (MT TX/RX) is scheduled. The condition for performing simultaneous communication may include a condition (Hereafter, the Eighth Condition) under which the first communication (DU communication) is scheduled when simultaneous transmission is supported. The condition for performing the time communication may be a combination of two or more conditions selected from the seventh to eighth conditions described above.

### (5) Action and Effect

According to the above embodiment, the following action and effect can be obtained. Specifically, the IAB node (For example, radio communication node 100B) performs DU communication using a second DU resource that contains at least a first DU resource when the conditions for not performing simultaneous communication of DU communication and MT communication are satisfied. With such a configuration, the frequency resource can be properly used as a DU resource in the case where simultaneous communication is not performed.

Here, the background technology did not examine the case where simultaneous communication is not performed, because the study of allocating the frequency resource as a DU resource was advanced on the assumption of simultaneous communication. It should be noted that the implementation differs from the background technology in that it clarified how the frequency resource is used in the case where simultaneous communication is not performed.

Furthermore, the second DU resource used in the case where simultaneous communication is not performed may be larger than the first DU resource used in the case where simultaneous communication is performed. With such a configuration, the waste of frequency resources in the IAB node where simultaneous communication is not performed can be suppressed.

### (6) Modification Example 1

Modification example 1 is described below. The differences with respect to the embodiment are mainly described below.

In the embodiment, a case where the DU resource is a frequency resource is illustrated. In contrast, in the modification example 1, a case where the DU resource is a DU resource (T-F resource below) in both the time direction and the frequency direction is explained.

### (6.1) First Example

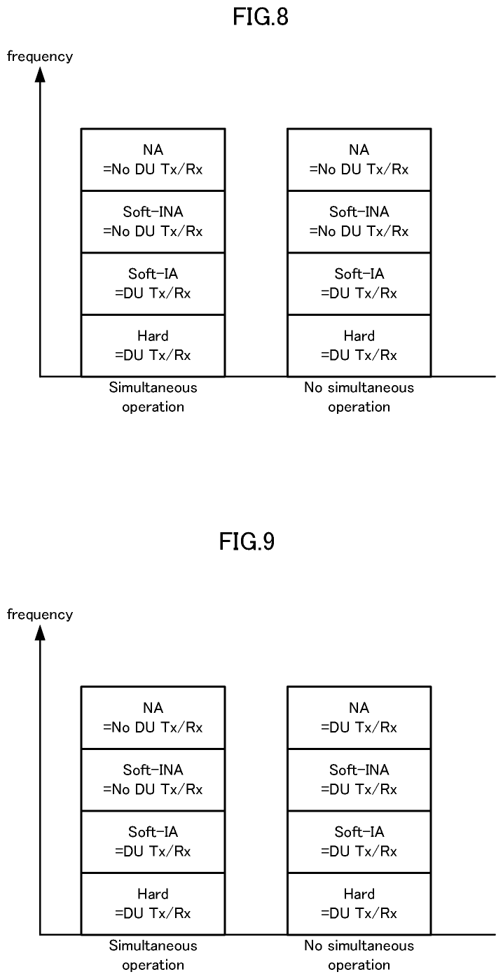

In the first example, as shown in FIG. 8, in the case where simultaneous communication is not performed, the second DU resource includes the DU resources of Hard and Soft-IA, but not the DU resources of Soft-INA and NA. That is, the second DU resource used in the case where simultaneous communication is not performed is the same as the first DU resource used in the case where simultaneous communication is performed. Since the IAB nodes (For example, radio communication node 100B) that do not perform simultaneous communication cannot use the DU resources of Soft-INA and NA for MT communication, the DU resources of Soft-INA and NA are not used.

### (6.2) Second Example

In the second example, as shown in FIG. 9, in the case where simultaneous communication is not performed, the second DU resource includes the DU resources of Hard, Soft-IA, Soft-INA and NA. That is, the second DU resource used in the case where simultaneous communication is not performed is larger than the first DU resource used in the case where simultaneous communication is performed. IAB nodes (For example, radio communication node 100B) that do not perform simultaneous communication may perform DU communication using DU resources of Soft-INA and NA in addition to Hard and Soft-IA.

### (6.3) Third Example

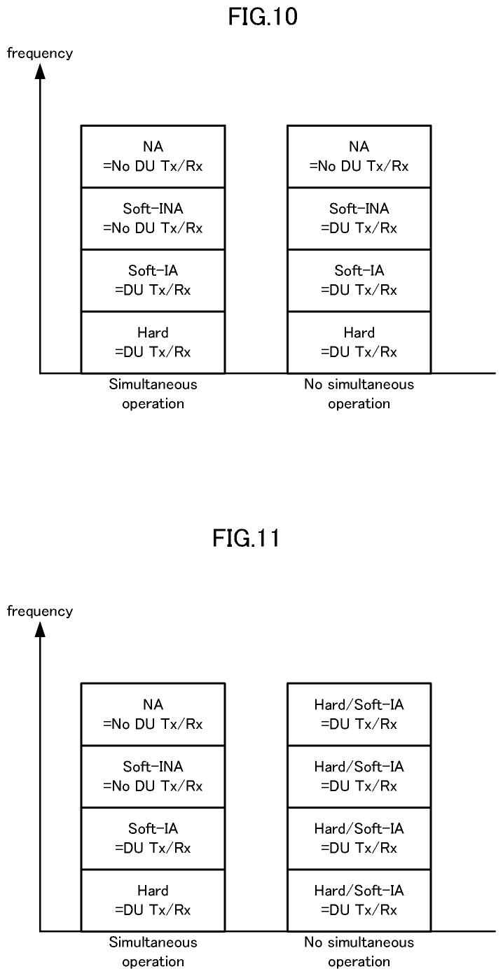

In the third example, as shown in FIG. 10, in the case where simultaneous communication is not performed, the second DU resource includes the DU resources of Hard, Soft-IA and Soft-INA, but not the DU resource of NA. That is, the second DU resource used in the case where simultaneous communication is not performed is larger than the first DU resource used in the case where simultaneous communication is performed. IAB nodes (For example, radio communication node 100B) that do not perform simultaneous communication may perform DU communication using DU resources of Soft-INA in addition to Hard and Soft-IA.

### (6.4) Fourth Example

In the fourth example, as shown in FIG. 11, an IAB node that does not perform simultaneous communication (For example, radio communication node 100B) may assume that all T-F resources are Hard and all T-F resources are Soft-IA. That is, the second DU resource used in the case where simultaneous communication is not performed is larger than the first DU resource used in the case where simultaneous communication is performed. IAB nodes that do not perform simultaneous communication may perform DU communication using all T-F resources.

In such cases, the UE 200 may assume that it is unable to perform MT communication with IAB nodes that do not perform simultaneous communication. On the other hand, the child node (For example, radio communication node 100C) may assume that it is able to perform DU communication using all frequency resources with IAB nodes that do not perform simultaneous communication.

### (6.5) Fifth Example

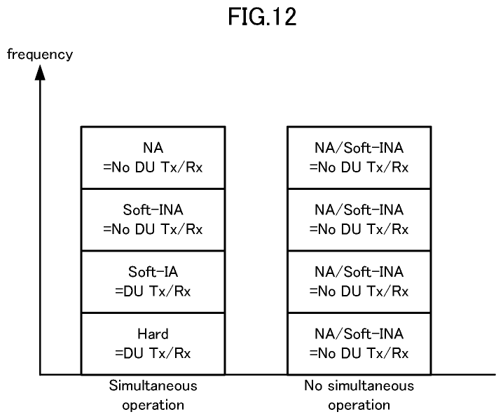

In the fifth example, as shown in FIG. 12, an LAB node that does not perform simultaneous communication (For example, radio communication node 100B) may assume that all T-F resources are NA or Soft-INA if the T-F resource contains NA. The IAB node may assume that all T-F resources are NA or Soft-INA if the T-F resource contains Soft-INA. In such cases, the IAB node may not perform DU communication. The IAB node may perform MT communication in all T-F resources.

In such a case, the UE 200 may assume that MT communication can be performed using all T-F resources with the IAB node on which concurrent communication is not performed. On the other hand, the child node (For example, radio communication node 100C) may assume that it cannot perform DU communication with the IAB node on which concurrent communication is not performed.

Although not specifically mentioned in Modification Example 1, the conditions for not performing concurrent communication may be the same as those in the above described embodiment. Similarly, the conditions for performing concurrent communication may be the same as those in the above described embodiment.

### (7) Other Embodiments

Although the above description of the embodiment is not limited to the description of the embodiment, it is obvious to those skilled in the art that various modifications and improvements are possible.

Although not specifically mentioned in the above described embodiment, a DCI that dynamically designates DU resources may be used. As the DCI, a DCI of DCI format 2 5 may be used (see 3GPP TS 38.212 Chapter 7.3). As the DCI, a DCI indicating whether frequency resources in the frequency direction can be used as DU resources may be used. The DCI may include resourceAvailability. The resourceAvailability may include the following values:
0 . . . No indication for availability of soft symbol
1 . . . DL soft symbol available, no indication for UL and Flexible soft symbol
2 . . . UL soft symbol available, no indication for DL and Flexible soft symbol
3 . . . DL and UL soft symbol available, no indication for Flexible soft symbol
4 . . . Flexible soft symbol available, no indication for DL and UL soft symbol
5 . . . DL and Flexible soft symbol available, no indication for UL
6 . . . UL and Flexible soft symbol available, no indication for DL
7 . . . DL, UL and Flexible soft symbol available

Flexible soft symbol is a soft symbol available for both DL and UL.

Although not specifically mentioned in the above described embodiment, capability information indicating whether or not an IAB node (For example, radio communication node 100B) supports FDM multiplexing Backhaul link (DU) and Access link (MT) may be defined. IAB nodes may report capacity information to IAB donors or parent nodes. The behavior of IAB nodes that do not perform simultaneous communication may be applied if capacity information is reported to support FDM. The behavior of IAB nodes that do not perform simultaneous communication may not be applied if capacity information is not reported to indicate whether they support FDM.

While not specifically addressed in the above described embodiment, the behavior of IAB nodes that do not perform simultaneous communication may be applied if configured by higher layer signaling. The behavior of LAB nodes that do not perform simultaneous communication may not be applied if not configured by higher layer signaling.

In the above described embodiment, the names of the parent node, the IAB node and the child node are used, but the names may be different as long as the configuration of the radio communication node is adopted in which the radio backhaul between the radio communication nodes such as gNB and the radio access to the terminal are integrated. For example, it may be simply referred to as the first or second node, or it may be referred to as the upper node, lower node or relay node, intermediate node, etc.

Furthermore, the radio communication node may be simply referred to as a communication device or a communication node, or may be read as a radio base station.

The block diagram (FIG. 3) used to describe the above embodiment shows a block of functional units. Those functional blocks (structural components) can be realized by a desired combination of at least one of hardware and software. Means for realizing each functional block is not particularly limited. That is, each functional block may be realized using one physically or logically coupled device, or two or more physically or logically separated devices may be directly or indirectly connected (For example, using wired, wireless, etc.) and realized using these multiple devices. The functional block may be realized by combining the software with the one device or the multiple devices.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission function is called a transmission unit (transmitting unit) or a transmitter. In either case, as described above, the implementation method is not particularly limited.

In addition, the radio communication nodes 100A to 100C (the device) described above may function as a computer for processing the radio communication method of this disclosure. FIG. 13 shows an example of the hardware configuration of the device. As shown in FIG. 13, the device may be configured as a computer device including a processor 1001, a memory 1002, a storage 1003, a communication device 1004, an input device 1005, an output device 1006, a bus 1007, etc.

Furthermore, in the following explanation, the term “device” can be replaced with a circuit, device, unit, and the like. The hardware configuration of the device may be configured to include one or more of each device shown in the figure, or it may be configured without some devices.

Each functional block of the device (see FIG. 3) is realized by any hardware element of the computer device, or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. The processor 1001 may consist of a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. In addition, the various processes described above may be performed by a single processor 1001 or simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, etc. Memory 1002 may store programs (program code), software modules, etc., that are capable of executing a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. The bus 1007 may be configured using a single bus or different buses for each device.

In addition, the device may include hardware such as a microprocessor, a digital signal processor (DSP), an application specific integrated circuit (ASIC), a programmable logic device (PLD), or a field programmable gate array (FPGA), with which some or all of the functional blocks may be implemented. For example, the processor 1001 may be implemented by using at least one of these hardware.

Also, the notification of information is not limited to the mode/embodiment described in this disclosure and may be made using other methods. For example, the notification of information may be carried out by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. The RRC signaling may also be referred to as an RRC message, e.g., an RRC Connection Setup message, an RRC Connection Reconfiguration message, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative order to present elements of various steps and is not limited to the specific order presented.

The specific operation that is performed by the base station in the present disclosure may be performed by its upper node in some cases. In a network consisting of one or more network nodes with base stations, it is clear that various operations performed for communication with terminals can be performed by the base station and at least one of the other network nodes (For example, but not limited to MME or S-GW) other than the base station. In the above, an example in which there is one network node other than the base station is explained; however, a combination of a plurality of other network nodes (for example, MME and S-GW) may be used.

Information, signals (information, etc.) can be output from an upper layer (or lower layer) to a lower layer (or upper layer). It may be input and output via a plurality of network nodes.

The input/output information can be stored in a specific location (for example, a memory) or can be managed in a management table. Information that is input or output may be overwritten, updated, or appended. The information can be deleted after outputting. The inputted information can be transmitted to another device.

Decisions may be made by a value represented by a single bit (0 or 1), by a truth value (Boolean: true or false), or by comparing numbers (For example, a comparison with a given value).

Each aspect/embodiment described in this disclosure may be used alone, in combination, or switched as execution proceeds. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, if the software is transmitted from a website, server, or other remote source using at least one of wired technology (Coaxial cable, fiber optic cable, twisted pair, Digital subscriber Line (DSL), etc.) and wireless technology (Infrared, microwave, etc.), at least one of these wired and wireless technologies is included within the definition of a transmission medium.

Information, signals, or the like mentioned above may be represented by using any of a variety of different technologies. For example, data, instructions, commands, information, signals, bits, symbols, chips, etc. that may be referred to throughout the above description may be represented by voltage, current, electromagnetic wave, magnetic field or magnetic particle, light field or photon, or any combination thereof.

It should be noted that the terms described in this disclosure and those terms necessary for the understanding of this disclosure may be replaced with terms having the same or similar meanings. For example, at least one of the channels and symbols may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

A base station can house one or more (For example, three) cells, also called sectors. In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a base station performing communication services in this coverage and to part or all of the coverage area of at least one of the base station subsystems.

In the present disclosure, the terms “mobile station (Mobile Station: MS),” “user terminal,” “user equipment (User Equipment: UE),” “terminal” and the like can be used interchangeably.

A mobile station may be referred to by those skilled in the art as a subscriber station, mobile unit, subscriber unit, radio unit, remote unit, mobile device, radio communication device, remote device, mobile subscriber station, access terminal, mobile terminal, radio terminal, remote terminal, handset, user agent, mobile client, client, or some other appropriate term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, airplanes, etc.), an unattended mobile (For example, drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in this disclosure may also be read as a mobile station (user terminal, hereinafter the same). For example, each mode/embodiment of this disclosure may be applied to a configuration in which communication between a base station and a mobile station is replaced with communication between multiple mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”). For example, terms an uplink channel, a downlink channel, or the like may be read as a side channel.

Similarly, mobile stations in this disclosure may be replaced with base stations. In this case, the base station may have the function of the mobile station. A radio frame may consist of one or more frames in the time domain. Each one or more frames in the time domain may be referred to as a subframe. A subframe may further consist of one or more slots in the time domain. A subframe may have a fixed length of time (For example, 1 ms) independent of numerology.

Numerology may be a communication parameter applied to at least one of the transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

Slots may consist of one or more symbols (Orthologous Frequency Division Multiplexing (OFDM)) symbols, Single Carrier Frequency Division Multiple Access (SC-FDMA) symbols, etc., in the time domain. A slot may be a unit of time based on the numerology.

A slot may include a plurality of minislots. Each minislot may consist of one or more symbols in the time domain. A minislot may also be called a subslot. A minislot may be composed of fewer symbols than slots. A PDSCH (or PUSCH) transmitted in units of time larger than the minislot may be referred to as a PDSCH (or PUSCH) mapping type A. A PDSCH (or PUSCH) transmitted using the minislot may be referred to as a PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called the transmission time interval (TTI), multiple consecutive subframes may be called TTI, or one slot or one minislot may be called TTI. That is, at least one of the subframes and TTI may be a subframe (1 ms) in existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

If one slot or one minislot is called a TTI, one or more TTIs (That is, one or more slots or one or more minislots) may be the minimum unit of time for scheduling. In addition, the number of slots (number of minislots) constituting the minimum unit of time for scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTIs that are usually shorter than TTI may be called shortened TTI, short TTI, partial or fractional TTI, shortened subframe, short subframe, minislot, subslot, slot, etc.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

A resource block (RB) is a unit of resource allocation in the time and frequency domains and may include one or more consecutive subcarriers in the frequency domain. The number of subcarriers included in RB may be, for example, twelve, and the same regardless of the topology. The number of subcarriers included in the RB may be determined based on the neurology.

The time domain of the RB may also include one or more symbols and may be one slot, one minislot, one subframe, or one TTI long. One TTI, one subframe, and the like may each consist of one or more resource blocks.

One or more RBs may be referred to as Physical RB (PRB), Sub-Carrier Group (SCG), Resource Element Group (REG), PRB pair, RB pair, and the like.

A resource block may also be composed of one or more Resource Elements (RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs relative to the common reference point of the carrier. PRB may be defined in BWP and numbered within that BWP.

BWP may include UL BWP (UL BWP) and DL BWP (DL BWP). For a UE, one or more BWPs may be set within a carrier.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, configurations such as the number of subframes contained in a radio frame, the number of subframes or slots per radio frame, the number of minislots contained in a slot, the number of symbols and RBs contained in a slot or minislot, the number of subcarriers contained in an RB, and the number of symbols, symbol length, and Cyclic Prefix (CP) length in a TTI can be varied variably.

The terms “connected,” “coupled” or any variation thereof mean any connection or combination, directly or indirectly, between two or more elements and may include the presence of one or more intermediate elements between two elements that are “connected” or “coupled” to each other. The connection or connection between elements may be physical, logical or a combination thereof. For example, “connection” may be read as “access.” As used in this disclosure, two elements may be considered to be “connected” or “coupled” to each other using at least one of one or more wire, cable and printed electrical connections and, as a few non-limiting and non-comprehensive examples, electromagnetic energy with wavelengths in the radio frequency domain, the microwave domain and the optical (both visible and invisible) domain.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to elements using designations such as “first” or “second” as used in this disclosure does not generally limit the amount or order of those elements. Such designations can be used in the present disclosure as a convenient way to distinguish between two or more elements. Thus, references to the first and second elements do not imply that only two elements can be adopted there or that the first element must in some way precede the second element.

In the present disclosure, the used terms “include,” “including,” and variants thereof are intended to be inclusive in a manner similar to the term “comprising.” Furthermore, the term “or (or)” as used in this disclosure is not intended to be an exclusive OR.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” or “determination” may include regarding some action as “judgment” or “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
100A, 100B, 100C Radio communication node
110 Radio signal transmission and reception unit
120 Amplifier unit
130 Modulation and demodulation unit
140 Control signal processing unit
150 Encoding/decoding unit
160 Data transmission and reception unit
170 Control unit
200 UE
C1, C2, C3 Cells
1001 Processor
1002 Memory
1003 Storage
1004 Communication device
1005 Input device
1006 Output device
1007 Bus

1. A radio communication node comprising:
a control unit that a first communication using a first radio link with a lower node and a second communication using a second radio link with a terminal, wherein
the control unit:
controls the first communication using a first radio resource based on a configuration of a radio resource used in the first radio link, when performing a simultaneous communication of the first communication and the second communication, and
performs the first communication using a second radio resource at least including the first radio resource when a condition is satisfied not to perform the simultaneous communication of the first communication and the second communication.

2. The radio communication node according to claim 1, wherein
the first radio resource and the second radio resource are frequency resources in a frequency direction.

3. The radio communication node according to claim 1, wherein
the second radio resource is larger than the first radio resource.

4. The radio communication node according to claim 1, wherein
the conditions include at least one of a condition that the radio communication node does not support the simultaneous communication, a condition that the simultaneous communication is not configured, a condition that the second communication is not scheduled, and a condition that the first communication is scheduled at a time when the simultaneous transmission is not supported.

5. A radio communication method comprising:
a step A of controlling a first communication using a first radio link with a lower node and a second communication using a second radio link with a terminal, wherein
the step A includes:
controlling the first communication using a first radio resource based on a configuration of a radio resource used in the first radio link, when performing a simultaneous communication of the first communication and the second communication, and
performing the first communication using a second radio resource at least including the first radio resource when a condition is satisfied not to perform the simultaneous communication of the first communication and the second communication.

6. The radio communication node according to claim 2, wherein
the second radio resource is larger than the first radio resource.

7. The radio communication node according to claim 2, wherein
the conditions include at least one of a condition that the radio communication node does not support the simultaneous communication, a condition that the simultaneous communication is not configured, a condition that the second communication is not scheduled, and a condition that the first communication is scheduled at a time when the simultaneous communication is not supported.

8. The radio communication node according to claim 3, wherein
the conditions include at least one of a condition that the radio communication node does not support the simultaneous communication, a condition that the simultaneous communication is not configured, a condition that the second communication is not scheduled, and a condition that the first communication is scheduled at a time when the simultaneous communication is not supported.
